(19) United States
(12) Patent Application Publication
(10) Pub. No.: US 2005/0161471 A1
(43) Pub. Date: Jul. 28, 2005

(54) Container for multiple condiments

(76) Inventor: Bruce R. Grenda, Barrington, IL (US)

Correspondence Address: FRANK C. NICHOLAS;CARDINAL LAW GROUP, 1603 Orrington Avenue, Suite 2000, Evanston, IL, 60201, US

(21) Appl. No.: 11/040,883

(22) Filed: Jan. 21, 2005

Related U.S. Application Data
(60) Provisional application No. 60/539,232, filed on Jan. 26, 2004.

(51) Int. Cl. B65D 35/22; B67D 3/00

(52) U.S. Cl. 222/94

(57) ABSTRACT

A container for multiple condiments is provided. The container is a dual compartment container including a body portion having a first and second compartment formed therein. Each compartment includes a side wall having a radiused portion and a flange portion extending outward from a perimeter region of the compartments. The flange portion has a film receiving surface. The compartments are together sized to fit within a vehicle cupholder opening.

### RELATED APPLICATIONS

This application claims priority to U.S. Provisional Application 60/539,232 filed Jan. 26, 2004 and hereby incorporates the entirety of that application by reference.

### FIELD OF THE INVENTION

### Background of Invention

The invention relates to a container for multiple condiments.

Many restaurants offer condiments in small, portable, and inexpensive containers. For example, many fast food chains offer ketchup and mustard in small sealed pouches. Providing condiments in such a fashion offers an inexpensive and quick method for providing customers with the desired condiments.

Many people eat their food while driving or riding in a car, and use of prior art condiment containers presents several difficulties. First, it is difficult to place a container on a seat for ease in dipping or dispensing the condiment. This difficulty is compounded if multiple sauces are desired. For example, when eating “buffalo chicken wings,” many consumers like to dip the wing in a spicy hot sauce and also in a cool ranch dressing. Other consumers are dissatisfied with the amount of condiment provided with the food, and prefer the condiment “on the side.”

A novel container is desired that overcomes these and other disadvantages.

### SUMMARY OF THE INVENTION

One embodiment of the invention provides a dual compartment container including a body portion having a first and second compartment formed therein. Each compartment includes a side wall having a radiused portion and a flange portion extending outward from a perimeter region of the compartments. The flange portion has a film receiving surface. The compartments are together sized to fit within a vehicle cupholder opening.

Another embodiment of the invention provides a tray for fill and seal processing. The tray includes a plurality of dual compartment containers. Each container includes a body portion having a first and second compartment formed therein and a side wall having a radiused portion. Each compartment further includes a flange portion extending outward from a perimeter region of the compartments and a film receiving surface. The containers are together sized to fit within a vehicle cupholder opening and the flange portion having a film receiving surface, wherein the flanges are interconnected.

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof. It should be noted that no drawings are drawn to scale.

### BRIEF DESCRIPTION OF THE DRAWINGS

FIG. 1 is a top view of one embodiment of a container in accordance with one aspect of the invention;

FIG. 2A is a side view of one embodiment of a container in accordance with one aspect of the invention;

FIG. 2B is a side view of one embodiment of a container in accordance with one aspect of the invention;

FIG. 3 is a top view of one embodiment of a container disposed in a vehicle cupholder in accordance with one aspect of the invention; and

FIG. 4 is a perspective view of one embodiment of a tray in accordance with one aspect of the invention.

### DETAILED DESCRIPTION OF THE INVENTION

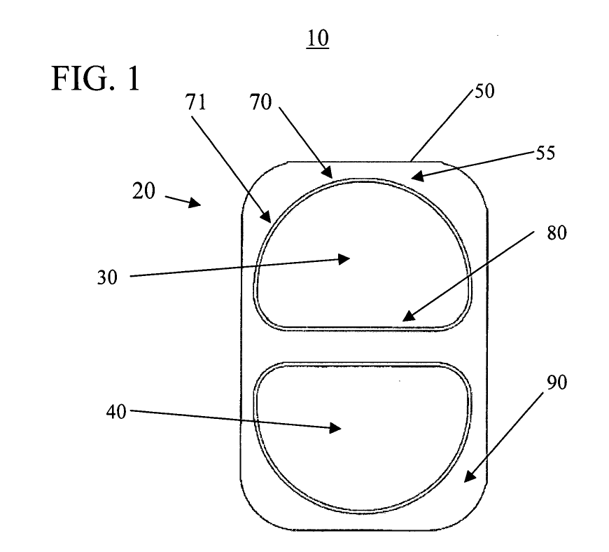

FIG. 1 illustrates one embodiment of a container in accordance with one aspect of the invention. FIG. 1 is a top view of a container 10 including a body portion 20. Body portion 20 includes a first compartment 30 and a second compartment 40. First and second compartments 30, 40 include at least one radiused portion 70. Body portion also includes a flange portion 50 extending radially outward from a perimeter region 55 of the compartments. Flange portion 50 includes a film receiving surface 90. FIG. 1 also indicates a second radiused portion 71. In one embodiment, second radiused portion 71 comprises a different radius than radiused portion 70.

In one embodiment, compartments 30, 40 also include a non-radiused portion 80. In one embodiment, the non-radiused portion of each compartment 30, 40 is proximate the non-radiused portion of the other compartment as compared with the radiused portion. In one embodiment, each compartment 30, 40 comprises a D-shaped configuration. In other embodiments, the configuration of each compartment may be polygonal, comma-shaped (yin-yang) or any other shape.

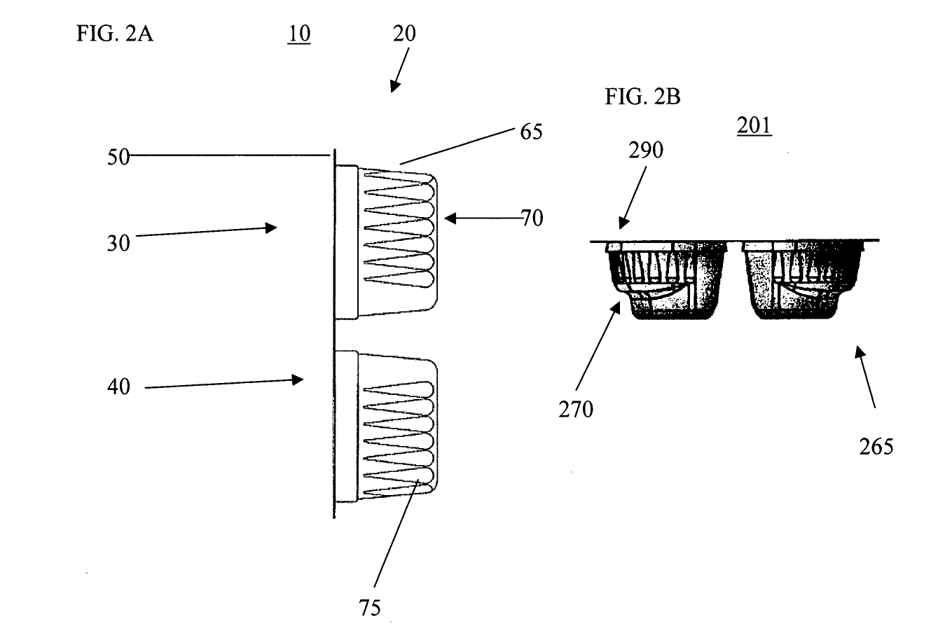

FIG. 2A is a side view of the embodiment illustrated in FIG. 1. As shown in FIG. 2A, container 10 includes first and second compartments 30, 40 and flange portion 50. First and second compartments include a side wall 65 having a radiused portion 70.

In one embodiment, side wall 65 comprises a tear-drop shape. In another embodiment, side wall 65 is a smooth wall. In other embodiments, side wall 65 may assume any configuration.

In another embodiment, the container may feature raised lugs 75 extending from the side wall 65. In one embodiment, the lug extends from the side wall near the location where the side wall contacts the flange portion. In embodiments featuring a lug, the lug serves to assist in vertically stacking the containers so that the containers are easily removed from each other. Lugs may completely encircle the perimeter of the container, or the lugs may be located in predetermined locations, such as at corners of the containers

FIG. 2B is a side view of a further embodiment of the invention. As shown in FIG. 2B, side wall 265 includes step 270. In one embodiment, step 270 includes a step surface substantially parallel to film receiving surface 290.

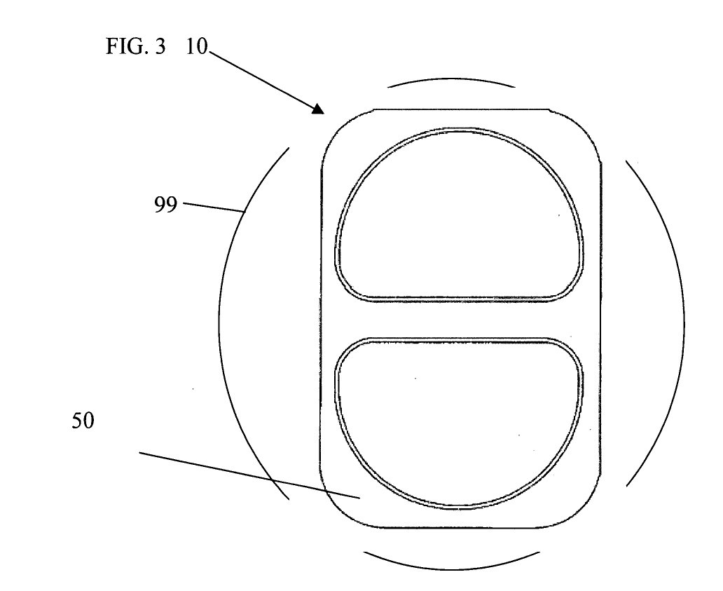

FIG. 3 illustrates the embodiment illustrated in FIG. 1 disposed within a vehicle cup holder 99. As shown in FIG. 3, the compartments 30, 40 are together sized to fit within a vehicle cupholder opening 99. In the embodiment illustrated in FIG. 3, the flange portion 50 is configured to rest atop the cupholder 99. In other embodiments, the flange portion may either be disposed within the cupholder (i.e. the cupholder is too large, and the container is disposed entirely within the cupholder), or the flange portion may rest above the cupholder (i.e. the side wall is sized such that it is longer than the depth of the cupholder). In another embodiment, such as that illustrated in FIG. 2B, the step surface rests atop the cup holder. It is an object of the invention to create a container that is sized to fit within a standard vehicle cupholder, as is known to those of ordinary skill in the art. Those of ordinary skill in the art understand that cupholders are made by a number of competing companies, and that cupholders are made to a number of different dimensions. However, most cupholders have a diameter of 4 inches or less. In one embodiment, a container according to the invention has a diameter of three inches or less.

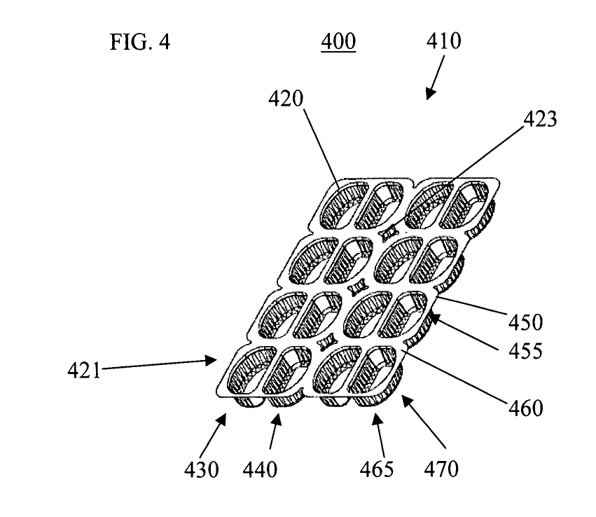

FIG. 4 illustrates one embodiment of a tray for fill and seal processing, in accordance with the invention. Tray 410 is illustrated at 400 including a plurality of dual compartment containers 420. At 400, eight dual compartment containers 420 are shown, in a 4×2 array of offset D-shaped configuration.

In one embodiment, containers 420 are implemented as container 10 illustrated in FIGS. 1 and 2. In such an embodiment, each container 420 includes a body portion 421 including a first compartment 430 and a second compartment 440 formed therein. Each compartment includes a side wall 465 having a radiused portion 470. Each container 420 further includes a flange portion 450 extending radially outward from a perimeter region 455 of the compartments. The flange 450 includes a film receiving surface 460.

In one embodiment, each container 420 is sized so that the compartments 430 and 440 together fit within a vehicle cupholder. In such an embodiment, the tray 410 is designed so that upon slitting of the tray into the component containers 420, each container is as described above in FIG. 3.

On the tray 410, flange 450 joins the plurality of containers 410 together into a single unitary tray. As shown in FIG. 4, the flange portions further create gaps 423. In one embodiment, gap 423 assumes a star configuration. Other configurations may include circular or polygonal configurations.

In one embodiment of the invention, a tray as described in FIG. 4 is provided. The tray is processed through a fill machine where each compartment is filled with a condiment. In one embodiment, the first compartment is filled with a condiment different than the condiment filled in the second compartment. For example, a buffalo hot sauce fills the first compartment, while a ranch dressing fills the second compartment. After filling the compartments with the condiment, a film is applied to the film receiving surface of the flange to seal the condiment within the compartments. The film may include a label identifying the contents of each compartment, as well as their source. After sealing, the tray is slit by means known in the art, and the resulting dual compartment containers are distributed.

In one embodiment, each of the first and second compartments are sized to hold approximately 1.5 ounces of condiment. In another embodiment, each of the first and second compartments is sized to hold between one-half ounce and four ounces of condiment. In another embodiment, each container is separately sized to hold a different amount of condiment.

While the preferred embodiments of the invention have been shown and described, numerous variations and alternative embodiments will occur to those of ordinary skill in the art. Accordingly, it is intended that the invention not be limited to as described, but also encompass the equivalents of the invention described, as well as any improvements which are obvious to those of ordinary skill in the art.

1. A dual compartment container comprising:
a body portion including a first and second compartment formed therein, each compartment including a side wall having a radiused portion;
a flange portion having a film receiving surface and extending outward from a perimeter region of the compartments; and
wherein the compartments are together sized to fit within a vehicle cupholder opening.

2. The container of claim 1 wherein the flange portion extends radially outward from a perimeter of the cupholder.

3. The container of claim 2 wherein the flange portion is configured to rest atop the cupholder.

4. The container of claim 1 wherein the side wall has at least two radiused portions.

5. The container of claim 4 wherein the at least two radiused portions comprise different radiuses.

6. The container of claim 1 wherein the compartments have a D-shaped configuration.

7. The container of claim 1 wherein the side wall includes a step.

8. A tray for fill and seal processing comprising:
a plurality of dual compartment containers each comprising a body portion including a first and second compartment formed therein, each compartment including a side wall having a radiused portion;
a flange portion having a film receiving surface and extending outward from a perimeter region of the compartments; and
wherein the containers are together sized to fit within a vehicle cupholder opening and wherein the flanges are interconnected.

9. The tray of claim 8 wherein the flange portion of each container extends radially outward from a perimeter of the container.

10. The tray of claim 8 wherein the flange portion is configured to rest atop the cupholder.

11. The tray of claim 8 wherein the side wall has at least two radiused portions.

12. The tray of claim 11 wherein the at least two radiused portions comprise different radiuses.

13. The tray of claim 8 wherein the compartments have a D-shaped configuration.

14. The tray of claim 8 wherein each side wall includes a step.

15. The tray of claim 8 wherein each compartment has a rectangular shape.
